(19) United States
(12) Patent Application Publication
(10) Pub. No.: US 2026/0320385 A1
(43) Pub. Date: Oct. 15, 2026

(54) APPARATUS, METHOD AND READABLE STORAGE MEDIUM FOR MODEL TRAINING

(71) Applicant: Huawei Technologies Co., Ltd., Shenzhen (CN)

(72) Inventors: Guile Wu, Shenzhen (CN); Tongtong Cao, Shenzhen (CN); Bingbing Liu, Shenzhen (CN)

(21) Appl. No.: 19/566,840

(22) Filed: Mar. 13, 2026

Related U.S. Application Data
(63) Continuation of application No. PCT/CN2023/119135, filed on Sep. 15, 2023.

(51) Int. Cl. G06N 3/08

(52) U.S. Cl. CPC G06N 3/08

(57) ABSTRACT

A model training apparatus is configured to obtain a plurality of intermediate models determined by performing iteration training on a neural network model, each intermediate model including values of model parameters such as model weights and statistics of the neural network model. The model training apparatus may perform weighted summation on the values of each model parameter in different intermediate models to obtain the value of the corresponding model parameter in an aggregated model. The model training apparatus may adopt the aggregated model as the training results of the neural network model while the iteration is completed, which is beneficial to improving the generalization performance of the trained neural network model.

### CROSS-REFERENCE TO RELATED APPLICATIONS

This application is a continuation of PCT International Patent Application Serial No. PCT/CN2023/119135 filed on Sep. 15, 2023, the content of which is incorporated herein by reference in its entirety.

### TECHNICAL FIELD

The present disclosure relates to the field of artificial intelligence, and more particularly, to an apparatus, method and readable storage medium for model training.

### BACKGROUND

Neural network models are generally obtained by performing multiple iteration training based on training data. During each iteration training, a training apparatus (e.g., a server) may first input the features in the training data into a neural network model to obtain an inference result. The training apparatus then determines a loss function based on the inference result and the tag in the training data. Finally, the training apparatus can adjust the model parameters of the neural network model according to the loss function. If the condition for terminating the training (for example, reaching the preset number of iterations, the value of the loss function reaching the preset value, the loss function is converged, etc.) is satisfied after a certain iteration training, the training apparatus terminates the iteration training and adopts the model parameter obtained by the last iteration training as the training result of the neural network model.

Since the number of model parameters is usually large, the iteration training process corresponds to a process of searching the optimal value of the model parameters in the high-dimensional space. However, the optimal value is generally unsolvable in the high-dimensional space. Therefore, the model parameters obtained by the last iteration training are generally a suboptimal value of the model parameters. Hence, the neural network model may output a high accuracy inference results for a part of the input data, while a low accuracy inference results for another part of input data, resulting in a poor generalization performance of the neural network model.

### SUMMARY

The present disclosure disclosed an apparatus, method, and readable storage medium for model training.

One or more embodiments can include an apparatus. The apparatus comprising: a memory for storing instructions; one or more processors for executing the instructions to cause the apparatus to: perform N iteration training on the first model, wherein N is an integer greater than 1; obtain M intermediate models in the N iteration training processes, and aggregate the M intermediate models to a second model, wherein M is an integer greater than 1; wherein aggregate the M intermediate models to obtain a second model comprising: aggregate the M intermediate models based on M model weights and M statistics corresponding to the M intermediate models.

In some implementations of the apparatus, the weights in the second model are aggregated with the M model weights in the M intermediate models, while the statistics in the second model are aggregated with the M statistics in the M intermediate models. Hence the second model may combine the performance of the M intermediate models, which is beneficial to improving the generalization performance of the trained neural network model.

One or more embodiments can include an apparatus, wherein: perform N iteration training on the first model comprising: aggregate the preceding K intermediate models of the M intermediate models to obtain a Kth aggregated model; update the model weights and the statistics of the Kth aggregated model to the first model; determine the (K+1)th intermediate model of the M intermediate models by performing at least one iteration training on the updated first model.

In some implementations of the apparatus, the (K+1)th intermediate model is obtained perform at least one iteration training on the updated first model with the model weights and the statistics of the Kth aggregated model, which benefits the converging speed of the iteration training.

One or more embodiments can include an apparatus, wherein: aggregate the preceding K intermediate models of the M intermediate models to obtain a Kth aggregated model comprising: obtain a (K−1)th aggregated model determined by aggregation of the Kth intermediate model and the preceding (K−1) intermediate models; determine a third value corresponding to the model weight in the Kth aggregated model based on performing weighted summation on a first value of the model weight in the Kth intermediate model and a second value of the model weight in the Kth aggregated model, and determine a sixth value corresponding to the statistics in the Kth aggregated model based on performing weighted summation on a fourth value of the statistics in the Kth intermediate model and a fifth value of the statistics in the Kth aggregated model.

In some implementations of the apparatus, the loss function in the first model is dynamically updated by a regularization term based on the aggregated model and the intermediate model, which is beneficial to improving the converging speed of the training of the neural network model and the accuracy of the training result.

One or more embodiments can include an apparatus, wherein: determine the (K+1)th intermediate model of the M intermediate models by performing at least one iteration training on the updated first model comprising: determine a regularization term based on the Kth intermediate model and the Kth aggregated model; update the loss function corresponding to the first model based on the regularization term; determine the (K+1)th intermediate model of the M intermediate models by performing at least one iteration training on the updated first model based on the updated loss function.

One or more embodiments can include an apparatus, wherein the first model comprises P layers, the model weight comprises a plurality of weights, and P is natural number; and determine a regularization term based on the Kth intermediate model and the Kth aggregated model comprising: determine gradient of each weights by inputting first data to the Kth aggregated model; determine the contribution of each layer to the loss function corresponding to the first model based on the gradient of each of the weights in each layer; determine the regularization term based on the contribution to the loss function corresponding to the first model of each layer, the first value of the model weight, and the third value of the model weight.

One or more embodiments can include an apparatus, wherein: determine the contribution of each layer to the loss function corresponding to the first model based on the gradient of each of the weights in each layer comprising: determine first norm corresponding to the gradient of weights in the Qth layer, and second norm corresponding to the gradient of all weights in the first model, wherein Q is a natural number less than or equal to P; determine the quotient of the first norm divided by the second norm as the contribution to the loss function corresponding to the first model of the Qth layer.

One or more embodiments can include an apparatus, wherein: determine the regularization term based on the contribution to the loss function corresponding to the first model of each layer, the first value of the model weight, and the third value of the model weight comprising: determine the regularization term according to the formula: R=Σα_{Q}×Δ_{Q}; wherein R is the regularization term, α_{Q} is the contribution to the loss function corresponding to the first model of Qth layer, Ao is the difference between the data corresponding to the Qth layer network in the first value and the data corresponding to the Qth layer network in the third value.

One or more embodiments can include an apparatus, wherein: aggregate the M intermediate models based on M model weights and M statistics corresponding to the M intermediate models comprising: determine the first intermediate model of the M intermediate models as the initial model of the second model; aggregate the second intermediate model to the Mth intermediate model of the M intermediate models to the second model one by one; wherein the Pth intermediate model of the M intermediate models is aggregated to the second model by: obtaining the Pth intermediate model, wherein the Pth intermediate model comprises a seventh value of the model weight and an eighth value of the statistics, 1<P≤M; updating the model weight in the second model to a ninth value, and updating the statistics in the second model to a tenth value, wherein the ninth value is the weighted sum of the seventh value and the current value of the model weight in the second model, the tenth value is the weighted sum of the eighth value and the current value of the statistics in the second model.

One or more embodiments can include a method. The method comprising: perform N iteration training on the first model, wherein N is an integer greater than 1; obtain M intermediate models in the N iteration training processes, and aggregate the M intermediate models to a second model, wherein M is an integer greater than 1; wherein aggregate the M intermediate models to obtain a second model comprising: aggregate the M intermediate models based on M model weights and M statistics corresponding to the M intermediate models.

One or more embodiments can include a method, wherein: perform N iteration training on the first model comprising: aggregate the preceding K intermediate models of the M intermediate models to obtain a Kth aggregated model; update the model weights and the statistics of the Kth aggregated model to the first model; determine the (K+1)th intermediate model of the M intermediate models by performing at least one iteration training on the updated first model.

In some implementations of the method, the weights in the second model are aggregated with the M model weights in the M intermediate models, while the statistics in the second model are aggregated with the M statistics in the M intermediate models. Hence the second model may combine the performance of the M intermediate models, which is beneficial to improving the generalization performance of the trained neural network model.

One or more embodiments can include a method, wherein: aggregate the preceding K intermediate models of the M intermediate models to obtain a Kth aggregated model comprising: obtain a (K−1)th aggregated model determined by aggregation of the Kth intermediate model and the preceding (K−₁) intermediate models; determine a third value corresponding to the model weight in the Kth aggregated model based on performing weighted summation on a first value of the model weight in the Kth intermediate model and a second value of the model weight in the Kth aggregated model, and determine a sixth value corresponding to the statistics in the Kth aggregated model based on performing weighted summation on a fourth value of the statistics in the Kth intermediate model and a fifth value of the statistics in the Kth aggregated model.

One or more embodiments can include a method, wherein: determine the (K+1)th intermediate model of the M intermediate models by performing at least one iteration training on the updated first model comprising: determine a regularization term based on the Kth intermediate model and the Kth aggregated model; update the loss function corresponding to the first model based on the regularization term; determine the (K+1)th intermediate model of the M intermediate models by performing at least one iteration training on the updated first model based on the updated loss function.

One or more embodiments can include a method, wherein the first model comprises P layers, the model weight comprises a plurality of weights, and P is natural number; and determine a regularization term based on the Kth intermediate model and the Kth aggregated model comprising: determine gradient of each weights by inputting first data to the Kth aggregated model; determine the contribution of each layer to the loss function corresponding to the first model based on the gradient of each of the weights in each layer; determine the regularization term based on the contribution to the loss function corresponding to the first model of each layer, the first value of the model weight, and the third value of the model weight.

One or more embodiments can include a method, wherein: determine the contribution of each layer to the loss function corresponding to the first model based on the gradient of each of the weights in each layer comprising: determining first norm corresponding to the gradient of weights in the Qth layer, and second norm corresponding to the gradient of all weights in the first model, wherein Q is a natural number less than or equal to P; determining the quotient of the first norm divided by the second norm as the contribution to the loss function corresponding to the first model of the Qth layer; wherein the regularization term is determined according to the formula: R=Σα_{Q}×Δ_{Q}, wherein R is the regularization term, aα_{Q} is the contribution to the loss function corresponding to the first model of Qth layer, α_{Q} is the difference between the data corresponding to the Qth layer network in the first value and the data corresponding to the Qth layer network in the third value.

One or more embodiments can include a method, wherein: determine the regularization term based on the contribution to the loss function corresponding to the first model of each layer, the first value of the model weight, and the third value of the model weight comprising: determine the regularization term according to the formula: R=Σα_{Q}×Δ_{Q}; wherein R is the regularization term, α_{Q} is the contribution to the loss function corresponding to the first model of Qth layer, Δ_{Q} is the difference between the data corresponding to the Qth layer network in the first value and the data corresponding to the Qth layer network in the third value.

One or more embodiments can include a method, wherein: aggregate the M intermediate models based on M model weights and M statistics corresponding to the M intermediate models comprising: determine the first intermediate model of the M intermediate models as the initial model of the second model; aggregate the second intermediate model to the Mth intermediate model of the M intermediate models to the second model one by one; wherein the Pth intermediate model of the M intermediate models is aggregated to the second model by: obtaining the Pth intermediate model, wherein the Pth intermediate model comprises a seventh value of the model weight and an eighth value of the statistics, 1<P≤M; updating the model weight in the second model to a ninth value, and updating the statistics in the second model to a tenth value, wherein the ninth value is the weighted sum of the seventh value and the current value of the model weight in the second model, the tenth value is the weighted sum of the eighth value and the current value of the statistics in the second model.

One or more embodiments can include a machine-readable storage medium. The machine-readable storage medium storing instructions, wherein the instructions when executed by one or more processors of a machine, cause the machine to: perform N iteration training on the first model, wherein N is an integer greater than 1; obtain M intermediate models in the N iteration training processes, and aggregate the M intermediate models to a second model, wherein M is an integer greater than 1; wherein aggregate the M intermediate models to obtain a second model comprising: aggregate the M intermediate models based on M model weights and M statistics corresponding to the M intermediate models.

In some implementations of the machine-readable storage medium, the weights in the second model are aggregated with the M model weights in the M intermediate models, while the statistics in the second model are aggregated with the M statistics in the M intermediate models. Hence the second model may combine the performance of the M intermediate models, which is beneficial to improving the generalization performance of the trained neural network model.

One or more embodiments can include a machine-readable storage medium, wherein: perform N iteration training on the first model comprising: aggregate the preceding K intermediate models of the M intermediate models to obtain a Kth aggregated model; update the model weights and the statistics of the Kth aggregated model to the first model; determine the (K+1)th intermediate model of the M intermediate models by performing at least one iteration training on the updated first model.

One or more embodiments can include a machine-readable storage medium, wherein: aggregate the preceding K intermediate models of the M intermediate models to obtain a Kth aggregated model comprising: obtain a (K−1)th aggregated model determined by aggregation of the Kth intermediate model and the preceding (K−1) intermediate models; determine a third value corresponding to the model weight in the Kth aggregated model based on performing weighted summation on a first value of the model weight in the Kth intermediate model and a second value of the model weight in the Kth aggregated model, and determine a sixth value corresponding to the statistics in the Kth aggregated model based on performing weighted summation on a fourth value of the statistics in the Kth intermediate model and a fifth value of the statistics in the Kth aggregated model.

One or more embodiments can include a machine-readable storage medium, wherein: determine the (K+1)th intermediate model of the M intermediate models by performing at least one iteration training on the updated first model comprising: determine a regularization term based on the Kth intermediate model and the Kth aggregated model; update the loss function corresponding to the first model based on the regularization term; determine the (K+1)th intermediate model of the M intermediate models by performing at least one iteration training on the updated first model based on the updated loss function.

One or more embodiments can include a machine-readable storage medium, wherein the first model comprises P layers, the model weight comprises a plurality of weights, and P is natural number; and determine a regularization term based on the Kth intermediate model and the Kth aggregated model comprising: determine gradient of each weights by inputting first data to the Kth aggregated model; determine the contribution of each layer to the loss function corresponding to the first model based on the gradient of each of the weights in each layer; determine the regularization term based on the contribution to the loss function corresponding to the first model of each layer, the first value of the model weight, and the third value of the model weight.

One or more embodiments can include a machine-readable storage medium, wherein: determine the contribution of each layer to the loss function corresponding to the first model based on the gradient of each of the weights in each layer comprising: determine first norm corresponding to the gradient of weights in the Qth layer, and second norm corresponding to the gradient of all weights in the first model, wherein Q is a natural number less than or equal to P; determine the quotient of the first norm divided by the second norm as the contribution to the loss function corresponding to the first model of the Qth layer.

One or more embodiments can include a machine-readable storage medium, wherein: determine the regularization term based on the contribution to the loss function corresponding to the first model of each layer, the first value of the model weight, and the third value of the model weight comprising: determine the regularization term according to the formula: R=Σα_{Q}×Δ_{Q}; wherein R is the regularization term, α_{Q} is the contribution to the loss function corresponding to the first model of Qth layer, Δ_{Q} is the difference between the data corresponding to the Qth layer network in the first value and the data corresponding to the Qth layer network in the third value.

One or more embodiments can include a machine-readable storage medium, wherein: aggregate the M intermediate models based on M model weights and M statistics corresponding to the M intermediate models comprising: determine the first intermediate model of the M intermediate models as the initial model of the second model; aggregate the second intermediate model to the Mth intermediate model of the M intermediate models to the second model one by one; wherein the Pth intermediate model of the M intermediate models is aggregated to the second model by: obtaining the Pth intermediate model, wherein the Pth intermediate model comprises a seventh value of the model weight and an eighth value of the statistics, 1<P≤M; updating the model weight in the second model to a ninth value, and updating the statistics in the second model to a tenth value, wherein the ninth value is the weighted sum of the seventh value and the current value of the model weight in the second model, the tenth value is the weighted sum of the eighth value and the current value of the statistics in the second model.

One or more embodiments can include an apparatus. The apparatus comprising: a memory for storing instructions; one or more processors for executing the instructions to cause the apparatus to: obtain a Kth intermediate model by performing iteration training on the first model with a loss function; determine a regulation term based on the Kth intermediate model and a (K−1)th intermediate model; update the regulation term into the loss function and perform iteration training on the first model based on the updated loss function.

One or more embodiments can include an apparatus, wherein the first model comprises P layers and a plurality of weights, the value of the weights in the Kth intermediate model is a first value, the value of the weights in the (K−1)th intermediate model is a second value, and P is natural number; and determine a regulation term based on the Kth intermediate model and a (K−1)th intermediate model comprising: determine gradient of each weights by inputting first data to the Kth intermediate model; determine the contribution of each layer to the loss function based on the gradients of weights in each layer; determine the regularization term based on the contribution of each layer to the loss function, the first value and the second value.

One or more embodiments can include an apparatus, wherein: determine the regularization term based on the contribution of each layer to the loss function, the first value and the second value comprising: determine first norm corresponding to the gradient of weights in the Qth layer, and second norm corresponding to the gradient of all weights in the first model, wherein Q is a natural number less than or equal to P; determine the quotient of the first norm divided by the second norm as the contribution to the loss function corresponding to the first model of the Qth layer.

One or more embodiments can include an apparatus, wherein: determine the regularization term based on the contribution of each layer to the loss function, the first value and the second value comprising: determine the regularization term according to the formula: R=Σα_{Q}×Δ_{Q}; wherein R is the regularization term, Δ_{Q} is the contribution to the loss function corresponding to the first model of Qth layer, Δ_{Q} is the difference between the data corresponding to the Qth layer network in the first value and the data corresponding to the Qth layer network in the second value.

### BRIEF DESCRIPTION OF THE FIGURES

The foregoing summary, as well as the following detailed description of the exemplary embodiments, will be better understood when read in conjunction with the appended drawings. For the purpose of illustrating the present disclosure, there are shown in the drawings embodiments, which are presently preferred. However, the present disclosure is not limited to the precise arrangements and instrumentalities shown.

FIG. 1 shows a schematic diagram of inference results of input data by a plurality of intermediate models according to some embodiments of the present disclosure;

FIG. 2 shows a schematic structural diagram of a model training apparatus 10 according to some embodiments of the present disclosure;

FIG. 3 shows a schematic process for a stabilization module 12 to update an aggregated model according to some embodiments of the present disclosure.

FIG. 4 shows a flow diagram of a model training method according to some embodiments of the present disclosure;

FIG. 5 shows a process diagram of a model training apparatus 10 implementing the model training method shown in FIG. 4, according to some embodiments of the present disclosure;

FIG. 6 shows a process diagram of a model training apparatus 10 determining regularization terms based on an aggregated model and an intermediate model, according to some embodiments of the present disclosure;

FIG. 7 shows a flow diagram of a model training method according to some embodiments of the present disclosure;

FIG. 8 shows a process diagram of a model training apparatus 10 dynamically updating regularization terms based on an intermediate model, according to some embodiments of the present disclosure;

FIG. 9 shows a flow diagram of another model training method according to some embodiments of the present disclosure;

FIG. 10 shows a schematic structural diagram of an electronic device 100 according to some embodiments of the present disclosure.

### DETAILED DESCRIPTION

Illustrative embodiments of the present disclosure include, but are not limited to apparatus, method, and readable storage media for model training.

As previously mentioned, if the model parameters obtained by the last iteration training are directly adopted as the training result of the neural network model, the neural network model may output a high accuracy inference results for a part of the input data, while a low accuracy inference results for another part of input data, resulting in a poor generalization performance of the neural network model.

For example, when training data is sparse and irregular (e.g., when training data includes point cloud data collected in the autopilot field), the neural network model converges to different sub-optimal results (i.e., different intermediate models are obtained) during iteration training. If the sub-optimal result is adopted as the training result of the neural network model, the neural network model may output a high accuracy inference results for a part of the input data, while a low accuracy inference results for another part of input data.

Illustratively, it is assumed that the correct inference results corresponding to the data set D1, the data set D2, and the data set D3 are the result R1, the result R2, and the result R3, respectively.

Referring to FIG. 1, intermediate models including intermediate model SM1, intermediate model SM2, and intermediate model SM3 are obtained during iteration training of the neural network model. The intermediate model SM1 outputs correct inference result for the data set D2 and the data set D3, while the inference result for the data set D1 is incorrect. The intermediate model SM2 outputs correct inference result for the data set D1 and the data set D3, while the inference result for the data set D2 is the incorrect. The intermediate model SM3 outputs correct inference result for the data set D1 and the data set D2, while the inference result for the data set D3 is incorrect. Therefore, adopting any one of the three intermediate models above as the training result causes the neural network model to be able to infer the correct result for only part of the input data, which affects the generalization performance of the neural network model.

In order to improve the generalization performance of a neural network model, the present disclosure provides a model training apparatus. The model training apparatus may determine an aggregated model by aggregating values of model parameters in a plurality of intermediate models (hereinafter referred to as intermediate model parameters) obtained during iteration training of a neural network model. And the model training apparatus may adopt the aggregated model as the training result of the neural network model. In some embodiments, the model parameters may include but not be limited to model weights and statistics.

For example, each time an intermediate model is obtained by the model training apparatus, the value of each model parameter in the intermediate model may be weighted summed with the value of corresponding model parameter in the aggregated model obtained last time to obtain the value of each model parameter in the new aggregated model (hereinafter referred to as the aggregated model parameter) (e.g., the value of one model parameter in the intermediate model and the value of the corresponding model parameter in the aggregated model obtained last time are respectively multiplied by the corresponding weighting coefficients and then added). Then, the model training apparatus may adopt the last updated aggregated model as the training result of the neural network model after the iteration training is completed.

In this way, since the values of the model parameters in the aggregated model are obtained by weighted summation based on the values of the model parameters in the multiple intermediate models, even if each intermediate model is a sub-optimal result, the trained model can take the performance of different sub-optimal results into account, which is beneficial to improving the generalization performance of the trained neural network model.

In some embodiments, the model weights are parameters updated by backpropagation in iteration training. For example, convolution weight of convolution layer, weight of each neuron in fully connected layer, and the like.

In some embodiments, the statistics are model parameters that are updated during iteration training, but not by back propagation. For example, running mean parameters and running std parameters in batch normalization layer are both statistics. Another example of this kind of statistic is adaptive dropout probability parameters in the dropout layer.

For ease of description, in the following embodiments, the model weights in the intermediate model parameters are referred to as intermediate weights, the statistics in the intermediate model parameters are referred to as intermediate statistics, the model weights in the aggregated model are referred to as aggregated weights, and the statistics in the aggregated model parameters are referred to as aggregation statistics.

In some embodiments, the model training apparatus may update the aggregated model multiple times during iteration training. Hence, the aggregated model may take into account the performance of more sub-optimal solutions, which further improves the generalization performance of the trained neural network model.

In some embodiments, after obtaining an aggregated model, the model training apparatus may update model parameters in the aggregated model (hereinafter referred to as aggregated model parameters, e.g., aggregated weights, aggregated statistics, etc.) into the neural network model. In this way, the model training apparatus may perform iteration training with the aggregated model parameter as the initial value of the corresponding model parameters in subsequent iteration training, which facilitates increasing the converging speed of the neural network model and improving the accuracy of the training result.

In some embodiments, the model training apparatus may also determine a regularization term based on the aggregated model and the intermediate model. The regularization term can be added to the loss function of the subsequent iteration training of the neural network model by means of over-addition, weighted summation, and the like. So as to further improve the performance of the neural network model obtained during the subsequent iteration training and avoid over-fitting.

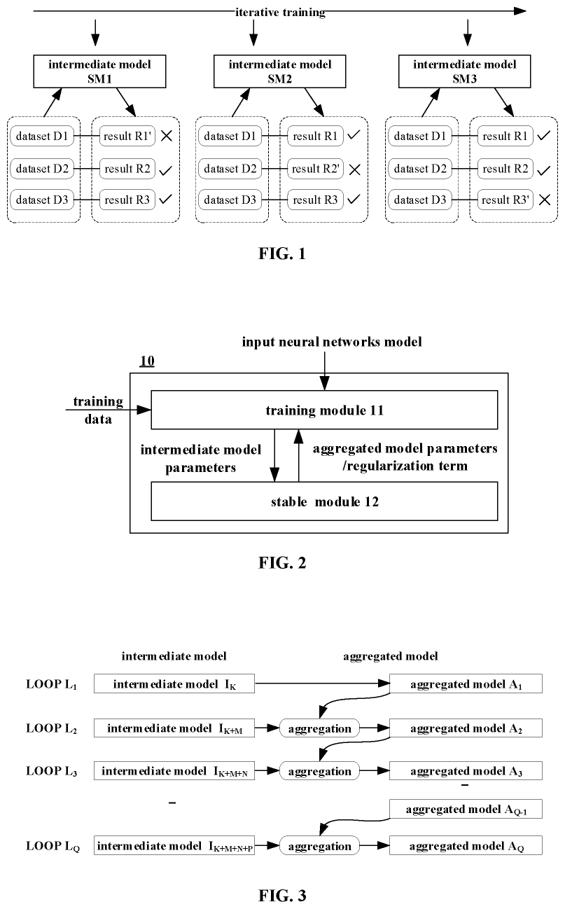

Illustratively, FIG. 2 shows a schematic structural diagram of model training apparatus 10 in accordance with some embodiments of the present disclosure.

As shown in FIG. 2, the model training apparatus 10 includes a training module 11 and a stabilization module 12.

The training module 11 is configured to perform iteration training on the input neural network model according to the input training data to obtain intermediate models. For example, the training module 11 may input the features in the training data into the neural network model to obtain an inference result corresponding to each feature. The training module 11 may then determine a loss function based on the inference results and tags corresponding to the features, and adjust the parameters of the neural network model based on the loss function.

In some embodiments, the training module 11 may adjust parameters of the neural network model through a backpropagation algorithm.

In some embodiments, the features in the training data are adopted as input data to the neural network model, and the tags in the training data are adopted as reference inference results for the corresponding features.

The stabilizing module 12 is configured to obtain intermediate model determined by the training module 11 and aggregate the obtained intermediate model with a previously determined aggregated model to obtain a new aggregated model.

For example, FIG. 3 shows a schematic process diagram of a stabilization module 12 updating an aggregated model according to some embodiments of the present disclosure.

As shown in FIG. 3:

In the first round of aggregation training, the stabilization module 12 adopted the intermediate model I_{K} determined in the Kth iteration training as the aggregated model A₁. Wherein K is a natural number.

In the second round of aggregation training, the stabilization module 12 obtains the intermediate model I_{K+M} determined in the (K+M)th iteration training. Then the intermediate model I_{K+M} and the aggregated model A₁ may be aggregated to obtain the aggregated model A2. Wherein M is a natural number.

For example, in some embodiments, assuming that the intermediate weight in the intermediate model I_{K+M} is IW_{K+M}, the intermediate statistics is IS_{K+M}, the aggregation weight of the aggregated model A1 is AW₁, and the aggregation statistics is AS₁, the aggregation weight of the aggregated model A2 is AW₂=ₐ×IW_{K+M}+(1-a)×AW₁, and the aggregation statistics is AS₂==b×IS_{K+M}+(1-b)×AS₁. Wherein a and b are positive numbers less than 1.

In the third round of aggregation training, the stabilization module 12 obtains the intermediate model I_{K+M+N} determined in the (K+M+N)th iteration training. Then the intermediate model I_{K+M+N} and the aggregated model A₂ may be aggregated to obtain the aggregated model A3. Wherein N is a natural number.

By analogy, in the Qth round of aggregation training, the stabilization module 12 obtains the intermediate model I_{K+M+N+P} determined in the (K+M+N+P)th iteration training. Then the intermediate model I_{K+M+N+P} and the aggregated model A_{Q-1} may be aggregated to obtain the aggregated model A_{Q}. Wherein P is a natural number.

In some embodiments, the stabilization module 12 may also be configured to determine a regularization term based on the intermediate model parameters and the resulting aggregated model. The regularization term may be used for subsequent iteration training of the neural network model.

For example, for the case shown in FIG. 3, after obtaining the aggregated model A2, the stabilization module 12 may obtain regularization term R based on the intermediate model parameters in the intermediate model I_{K+M} and the aggregated model parameters in aggregated model A2. Assuming that the loss function adopted for the (K+M)th iteration training in the training module 11 is L1=F+R0, where R0 is the regularization term in the loss function L1, the training module 11 may train the neural network model with the loss function λ₁×F+λ₂×R during the (K+M+1)th iteration training to the (K+M+N)th iteration training. The determination of the regularization term R will be described later.

In some embodiments, the stabilization module 12 may send the aggregated model parameters in the aggregated model to the training module 11 after determining an aggregated model, so that the training module 11 may adopt the aggregated model parameters as the initial values of model parameters in the next iteration training.

For example, for the case shown in FIG. 3, assuming the aggregated weights in the aggregated model A2 is AW₂=a×IW_{K+M}+(1-a)×AW₁ and the aggregated statistics in the aggregated model A2 is AS₂=b×IS_{K+M}+(1-b)×AS₁, the stabilization module 12 may send AW₂ and AS₂ to the training module 11. The training module 11 may first update the model weight of the neural network model to AW2 and update the statistics of the neural network model to AS₂, and then start the (K+M+1)th iteration training.

The structure of the model training apparatus 10 above is merely an example, and in other embodiments, the model training apparatus 10 may include more or fewer modules, or may combine or split parts of the modules, which are not limited herein.

Each module of the model training apparatus 10 may be deployed in one electronic device or in a plurality of electronic devices, and the functions of each module may be implemented by the processor of the electronic device in which each module is deployed by executing instructions.

In some embodiments, one module of the model training apparatus 10 may also be deployed in a plurality of electronic devices, which is not limited herein. For example, the training module 11 may be deployed in a plurality of electronic devices, and the plurality of electronic devices perform distributed training on the neural network model to obtain intermediate models corresponding to the neural network model. The stabilization module 12 may be deployed in one or more electronic devices for obtaining intermediate models from the electronic devices in which the training module 11 is deployed, and determining an aggregated model based on the obtained intermediate models and/or determining a regularization term based on the intermediate model and the aggregated model, and the like.

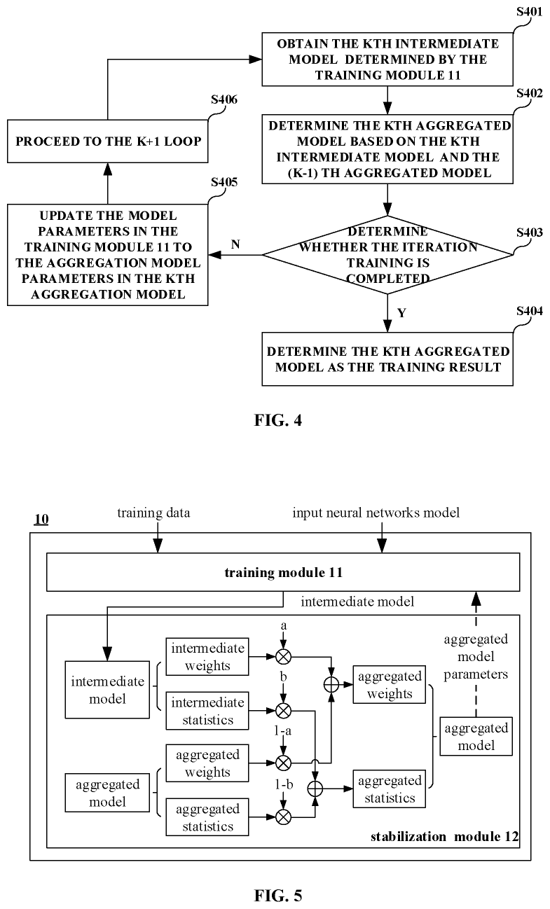

The technical solution of the present disclosure will be further described with reference to FIGS. 4 to 10.

FIG. 4 shows a flow diagram of a model training method according to some embodiments of the present disclosure; FIG. 5 shows a process diagram of a model training apparatus 10 implementing the model training method shown in FIG. 4, according to some embodiments of the present disclosure.

As shown in FIG. 4, the flow includes the following steps.

S401, obtain the kth intermediate model determined by the train module 11.

Illustratively, the stabilization module 12 may obtain the Kth intermediate model during the Kth (K is a natural number) loop of aggregation training, in which the Kth intermediate model is determined by the training module 11 during iteration training of the neural network model. The Kth intermediate model comprises intermediate model parameters corresponding to the neural network model, such as intermediate weights, intermediate statistics, and the like.

For example, referring to FIG. 5, the training module 11 may perform iteration training on the neural network model based on the input neural network model and training data. The stabilization module 12 may obtain the intermediate model obtained by any one iteration training from the training module 11 as the Kth intermediate model.

In some embodiments, the training module 11 may perform at least one iteration training on the neural network model to obtain at least one intermediate model during each loop of aggregation training. The stabilization module 12 may arbitrarily select an intermediate model from the at least one intermediate model as the Kth intermediate model. That is, the Kth intermediate model obtained by the stabilization module 12 may be an intermediate model obtained by the training module 11 during the Kth iteration training, or may be an intermediate model obtained by the training module 11 during the K+M (M≥1) th iteration training, which is not limited herein.

S402, determine the kth aggregated model based on the kth intermediate model and the (k−1) th aggregated model.

Illustratively, the stabilization module 12 may determine the Kth aggregated model based on the Kth intermediate model and the Kth aggregated model after obtaining the Kth intermediate model.

In some embodiments, in the case of K=1 (i.e., in the case where the stabilization module 12 obtains the intermediate model for the first time), the Kth aggregated model may be the Kth intermediate model.

In some embodiments, the stabilization module 12 may derive the aggregated weights in the Kth aggregated model by weighted summation of the intermediate weights in the Kth intermediate model with the aggregated weights in the Kth aggregated model. The stabilization module 12 may also obtain the aggregation statistics in the Kth aggregated model by weighted summation of the intermediate statistics in the Kth intermediate model and the aggregation statistics in the Kth aggregated model.

Illustratively, referring to FIG. 5, the stabilization module 12 may determine the aggregation weight in the Kth aggregated model by adding the product of intermediate weight in the Kth intermediate model and a to the product of the aggregation weight in the (K−1)th aggregated model and 1-a. The stabilization module 12 may also determine the aggregation statistics in the Kth aggregated model by adding the product of the intermediate statistics in the Kth intermediate model and b to the product of the aggregation statistics in the Kth intermediate model and 1-b. For example, assuming that the intermediate weights in the Kth intermediate model is IW_{K+M}, the intermediate statistics in the Kth intermediate model is IS_{K+M}, the aggregation weight in the (K−1)th aggregated model is AW₁, and the aggregation statistics in the (K−1)th aggregated model is AS1. The aggregation weight in the Kth aggregated model is AW₂₌ₐ×IW_{K+M}+(1-a)×AW₁, and the aggregation statistics in the Kth aggregated model is AS₂-b×IS_{K+M}+(1-b)×AS₁.

In some embodiments, the values of a and b may be set empirically, or may be set according to verifying the aggregated model with a verification dataset, which is not limited herein.

For example, assuming that when the Kth intermediate model and the (K−1)th aggregated model are verified by a certain verification dataset, the correct rate of the result obtained by the Kth intermediate model based on inferring the features in the verification dataset is c, and the correct rate of the result obtained by the (K−1)th aggregated model based on inferring the features in the verification dataset is d. Then a or b may be c/(c+d).

In some embodiments, the values of a and b may be the same or different, which are not limited herein.

In some embodiments, the values of a and b may also be determined by other means, which are not limited herein.

S403, determine if the iteration training is completed.

The stabilization module 12 determines whether the iteration training is completed. If the iteration training is completed, then proceed to step S404, otherwise, proceed to step S405.

In some embodiments, the stabilization module 12 may determine the iteration training completed when the condition for termination of the training is satisfied, and proceed to step S404.

In some embodiments, the condition of terminating training may include at least one of the following conditions:

The number of iteration training times reaches a preset number;

The loss functions are converged after iteration training.

S404, determine the kth aggregated model as the training results.

The stabilization module 12 adopts the Kth aggregated model as the training result while the iteration training is completed.

In some embodiments, the stabilization module 12 may send the Kth aggregated model to the training module 11, so that the training module 11 feeds the Kth aggregated model back to the user as a result of the training.

S405, update the model parameters in the train module 11 to the aggregated model parameters in the kth aggregated model.

The stabilization module 12 may update the aggregated model parameters in the Kth aggregated model into the training module 11. Hence the training module 11 may perform the next iteration training with the aggregated model parameters as the initial values of the model parameters, which benefits the converging speed of the training.

In some embodiments, the stabilization module 12 may also not update the model parameters in the training module 11 to the aggregated model parameters in the Kth aggregated model, which means step S405 may not be conducted.

S406, proceed to the k+1 loop.

In some embodiments, the model training apparatus 10 may repeat the foregoing steps S401 to S405 to perform the (K+1)th loop of the aggregation training after updating the model parameters in the training module 11 to the aggregated model parameters in the Kth aggregated model.

In some embodiments, the training module 11 may perform at least one iteration training on the neural network model in the (K+1)th loop of the aggregation training. In the (K+1)th loop of the aggregation training, the training module 11 may train the neural network model by adopting the aggregated model parameter of the Kth aggregated model as the initial value of the model parameters of the neural network model. In this way, it is advantageous to improve the converging speed of the neural network model and the training efficiency.

Based on the above method, since the values of the model parameters in the aggregated model are obtained by weighted summation the values of the model parameters in the multiple intermediate models, even if each intermediate model is a sub-optimal result, the aggregated model can combine the performance of different intermediate models, which is beneficial to improving the generalization performance of the trained neural network model.

Further, in some embodiments, the model training apparatus 10 may also determine a regularization term for the subsequent training process based on the aggregated model and the intermediate model in order to avoid over-fitting during iteration training of the neural network model by the training module 11.

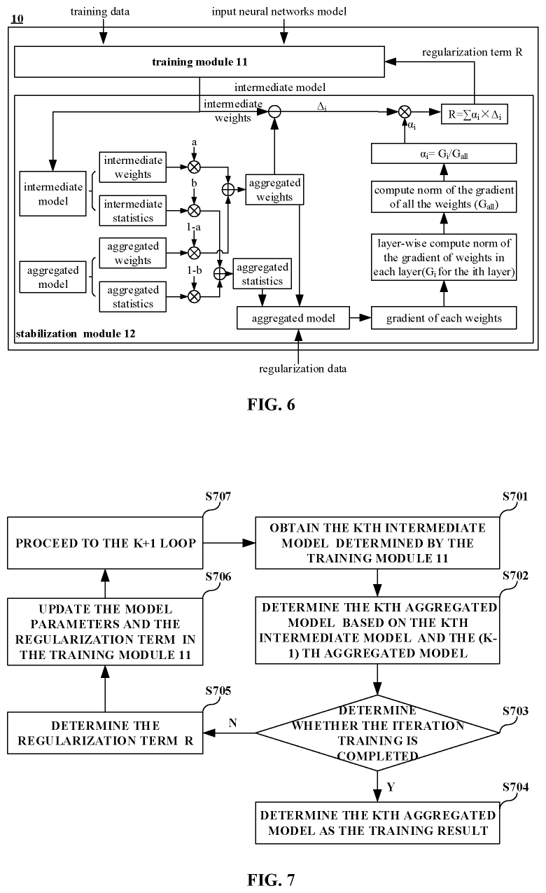

FIG. 6 shows a process diagram of a model training apparatus 10 determining regularization terms based on aggregated model and intermediate model according to some embodiments of the present disclosure.

As shown in FIG. 6, after obtaining an aggregated model, the stabilization module 12 may determine the regularization term used for subsequent iteration training by:

First, the stabilization module 12 may input the regularization data into the aggregated model to obtain the gradient of each weight in the aggregated model.

It should be understood that the regularization data may include at least part of the training data for iteration training of the neural network model by the training module 11, or may be training data different from the training data for iteration training of the neural network model by the training module 11, which is not limited herein.

In some embodiments, the stabilization module 12 may utilize backpropagation algorithm to derive the gradient of each weight in the aggregated model, such as static backpropagation algorithm, recurrent backpropagation algorithm, or the like.

In some embodiments, the gradient of a weight may indicate the contribution of the model weights to the loss function of the neural network model. The greater the gradient, the greater the change in the loss function while the weights changes.

Then, the stabilization module 12 may determine the norm of the gradient of the weights in each layer of the aggregated model (for ease of description, the norm of the model weights in ith layer is denoted as Gᵢ) and the norm of the gradients of all the weights in the aggregated model (denoted as Gₐₗₗ).

In some embodiments, the norm of the gradient of the weights in each layer (Gᵢ) and the norm of the gradient of all of the weights in the aggregated model (Gₐₗₗ) may be any type of norm, which including but not limited to L0 norm, L1 norm, L2 norm, L infinite norm, Frobenius norm, spectral norm (also referred to as induction norm), infinite norm, and the like.

In some embodiments, the norm of the gradient of the weights in each layer (Gᵢ) and the norm of the gradient of all of the weights in the aggregated model(Gₐₗₗ) may be the same type of norm. For example, both Gᵢ and Gₐₗₗ may be L2 norm.

Next, the stabilization module 12 may determine the contribution of each layer to the loss function corresponding to neural network model based on the norm of the gradient of the weights in each layer (Gᵢ) and the norm of the gradient of all of the weights in the aggregated model(Gₐₗₗ). For ease of description, the contribution of ith layer to the loss function corresponding to the neural network model is denoted as αᵢ.

In some embodiments, ai may be expressed as Gᵢ/Gₐₗₗ. The greater the value of αᵢ, the greater the change in the loss function while the weights in the ith layer change.

In some embodiments, the contribution of each layer to the loss function corresponding to neural network model may be determined by other means, which is not limited herein.

Finally, the stabilization module 12 may determine the regularization term R in the loss function during the next loop of aggregation training based on the intermediate weights, aggregation weights, and αᵢ.

In some embodiments, R may be determined by Σαᵢ×Δᵢ, wherein Δᵢ is the difference between the aggregation weights in the ith layer of the aggregated model and the intermediate weights in the -th layer of the intermediate model.

Illustratively, assuming that the matrix corresponding to the aggregated weights in the ith layer of the aggregated model is Wᵢ₁ and the matrix corresponding to the intermediate weights in the ith layer of the intermediate model is Wᵢ₂, Δᵢ may be denoted as Σ|(Wᵢₗ(m)-Wᵢ₂ (m))|or sqrt (Σ(Wᵢ₁(m)-Wᵢ₂(m))²). Wherein Wᵢ₁ (m) denotes the mth element of the matrix Wᵢ₁, Wᵢ₂(m) denotes the mth element of the matrix Wᵢ₂, sqrt( ) denotes a square root, and ∥ denotes an absolute value.

In some embodiments, the determination of the difference Δ₁ above is merely an example, and Δ₁ may be determined by other means in other embodiments, which is not limited herein.

In some embodiments, the stabilization module 12 may update the determined regularization term R to the loss function of the training module 11 so that the training module 11 may train the neural network model based on the updated loss function in the subsequent iteration training.

Illustratively, assuming that the loss function currently employed by the training module is L1=F+R0, the updated loss function L2 may be expressed as λ₁×F+λ₂×R. Wherein R0 is the regularization term in the loss function L1, λ₁ and λ₂ are any values that are not 0.

Based on the process shown in FIG. 6, some embodiments of the present disclosure further provide a model training method.

FIG. 7 shows a flow diagram of a model training method according to some embodiments of the present disclosure.

As shown in FIG. 7, the flow includes the following steps.

S701, obtain the kth intermediate model determined by the train module 11.

Illustratively, the stabilization module 12 may obtain the Kth intermediate model during the Kth (K is a natural number) loop of aggregation training, in which the Kth intermediate model is determined by the training module 11 during iteration training of the neural network model. The Kth intermediate model comprises intermediate model parameters corresponding to the neural network model, such as intermediate weights, intermediate statistics, and the like.

In some embodiments, the way in which the stabilization module 12 obtains the Kth intermediate model may refer to the foregoing step S401, and details are not described herein.

S702, determine the kth aggregated model based on the kth intermediate model and the (k−1)th aggregated model.

Illustratively, the stabilization module 12 may determine the Kth aggregated model based on the Kth intermediate model and the (K−1)th aggregated model.

In some embodiments, the way in which the stabilization module 12 determines the Kth aggregated model may refer to the foregoing step S402, and details are not described herein.

S703, determine whether the iteration training is completed.

The stabilization module 12 determines whether the iteration training is completed. If the iteration training is completed, then proceed step S704, otherwise proceed to step S705.

In some embodiments, the way in which the stabilization module 12 determines whether the iteration training is completed may refer to the foregoing step S403, and details are not described herein.

S704, determine the kth aggregated model as the training result.

The stabilization module 12 may adopt the Kth aggregated model as the training result of the neural network model while the iteration training is completed.

S705, determine the regularization term R.

The stabilization module 12 may determine the regularization term based on the Kth aggregated model and the Kth intermediate model while the iteration training is not completed.

In some embodiments, based on the embodiment shown in FIG. 6, the stabilization module 12 may determine the regularization term R by:

First, the stabilization module 12 may input the regularization data to the Kth aggregated model to obtain the gradient of each weight in the Kth aggregated model.

Then, the stabilization module 12 may determine the norm corresponding to the gradients of weights in the ith layer of the Kth aggregated model (denoted as Gᵢ) and the norm corresponding to the gradients of all the weights of the Kth aggregated model (denoted as Gᵢ).

Next, the stabilization module 12 may determine the contribution of ith layer to the loss function corresponding to the Kth aggregated model (denoted as αᵢ). For example, ai may be calculated by Gᵢ/Gₐₗₗ.

Finally, the stabilization module 12 may determine the regularization term R in the loss function during the next loop of aggregation training based on the intermediate weights, aggregated weights, and αᵢ.

For example, R may be calculated by Σαᵢ×αᵢ, wherein Δᵢ is the difference between the aggregated weights in the ith layer of the Kth aggregated model and the intermediate weights in ith layer of the Kth intermediate model.

S706, update the model parameters and the regularization term in the train module 11.

The stabilization module 12 may update the aggregated model parameters in the Kth aggregated model to the training module 11, and update the regularization term R to the loss function of the training module 11.

Illustratively, assuming that the loss function currently employed by the training module is L1=F+R0, the updated loss function L2 may be expressed as λ₁×F+λ₂×R. Wherein R0 is the regularization term in the loss function L1, λ₁ and λ₂ are any values that are not 0.

S707, proceed to the K+1 loop.

In some embodiments, the stabilization module 12 may repeat the foregoing steps S701 to S706 to perform the (K+1)th loop of aggregation training after updating the model parameters and the regularization term in the train module 11.

In some embodiments, the training module 11 may perform at least one iteration training on the neural network model based on the updated loss function. In the at least one iteration training process, the training module 11 may perform iteration training on the neural network model by adopting the aggregated model parameter of the Kth aggregated model as the initial value of the model parameter of the neural network model, which is advantageous to improve the converging speed of the neural network model and the training efficiency.

Based on the method above, since the values of the model parameters in the aggregated model are obtained by weighted summation based on the values of the model parameters in the multiple intermediate models, even if each intermediate model is a sub-optimal result, the aggregated model can combine the performance of different intermediate models, which is beneficial to improving the generalization performance of the trained neural network model. In addition, in the training process, the regularization term can be dynamically updated based on the aggregated model and the intermediate model, which is beneficial to improving the converging speed of the training of the neural network model and the accuracy of the training result.

In some embodiments, the model training apparatus 10 may not aggregate the intermediate model during the training of the neural network model, but dynamically update the regularization term to avoid over-fitting.

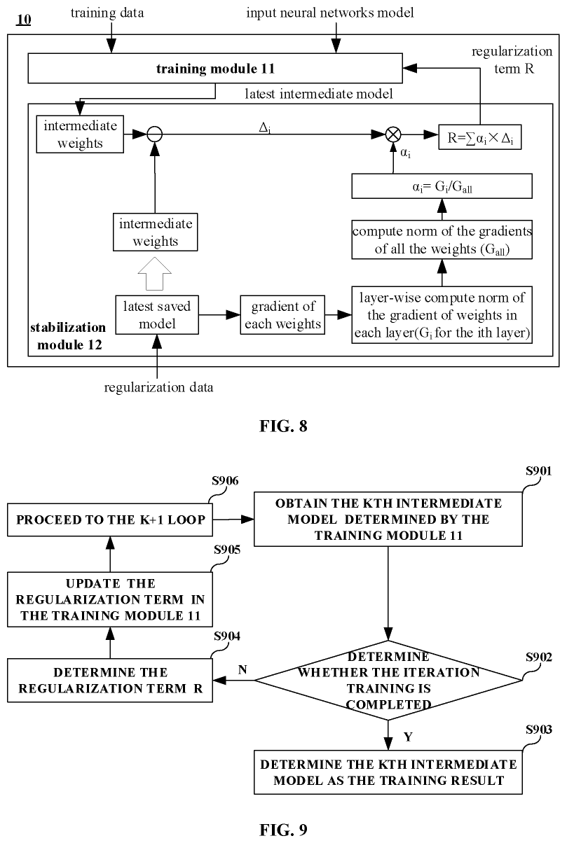

For example, FIG. 8 shows a process diagram of a model training apparatus 10 dynamically updating regularization terms based on an intermediate model according to some embodiments of the present disclosure.

As shown in FIG. 8, the stabilization module 12 may store the intermediate model determined by the training module 11 (hereinafter referred to as the latest saved model). After the training module 11 obtains a new intermediate model (hereinafter referred to as the latest intermediate model), the stabilization module 12 may determine the regularization term adopted for the subsequent iteration training by:

First, the stabilization module 12 may input the regularization data to the latest saved model to obtain the gradient of each weight in the latest saved model.

In some embodiments, the stabilization module 12 may utilize backpropagation algorithm to derive the gradient of each weight in the latest saved model.

Then, the stabilization module 12 may determine the norm corresponding to the gradients of weights in the ith layer of the latest saved model (denoted as Gᵢ) and the norm corresponding to the gradients of all the weights of the latest saved model (denoted as Gᵢ).

Next, the stabilization module 12 may determine the contribution of ith layer to the loss function corresponding to the latest saved model (denoted as αᵢ). For example, αᵢ may be calculated by Gᵢ/Gₐₗₗ.

Finally, the stabilization module 12 may determine the regularization term R in the loss function during the next loop of training based on the intermediate weights in the latest saved model, the intermediate weights in the latest intermediate model and αᵢ.

In some embodiments, R may be calculated by Σαᵢ×Δᵢ, wherein Δᵢ is the difference between the intermediate weights in the ith layer of the latest intermediate model and the intermediate weights in the ith layer of the latest saved model.

Illustratively, assuming that the matrix corresponding to the intermediate weights in the ith layer of the latest saved model is Wᵢ₃ and the matrix corresponding to the intermediate weights in the ith layer of the latest intermediate model is Wᵢ₄, Δᵢ may be denoted as Σ|(Wᵢ₃(m)-Wᵢ₄ (m))| or sqrt (>(Wi3(m)-Wᵢ₄(m))²). Wherein Wᵢ₃(m) denotes the mth element of the matrix Wᵢ₃, Wᵢ₄(m) denotes the mth element of the matrix Wᵢ₄, sqrt( ) denotes a square root, and ∥denotes an absolute value.

After determining the regularization term R, the stabilization module 12 may update the determined regularization term R to the loss function of the training module 11 so that the training module 11 may train the neural network model based on the updated loss function in the subsequent iteration training. Illustratively, assuming that the loss function currently employed by the training module is L1=F+R0, the updated loss function L2 may be expressed as λ₁×F+λ₂×R. Wherein R0 is the regularization term in the loss function L1, λ₁ and λ₂ are any values that are not 0.

Based on the process shown in FIG. 8, some embodiments of the present disclosure further provide a model training method.

FIG. 9 shows a flow diagram of another model training method according to some embodiments of the present disclosure.

As shown in FIG. 9, the flow includes the following steps.

S901, obtain the Kth intermediate model determined by the train module 11.

Illustratively, the stabilization module 12 may obtain the Kth intermediate model during the Kth (K is a natural number) loop of aggregation training, in which the Kth intermediate model is determined by the training module 11 during iteration training of the neural network model. The Kth intermediate model comprises intermediate model parameters corresponding to the neural network model, such as intermediate weights, intermediate statistics, and the like.

In some embodiments, the way in which the stabilization module 12 obtains the Kth intermediate model may refer to the foregoing step S401, and details are not described herein.

S902, determining whether the iteration training is completed.

The stabilization module 12 determines whether the iteration training is completed. If the iteration training is completed, then proceed to step S903, otherwise, proceed step S904.

In some embodiments, the way in which the stabilization module 12 determines whether the iteration training is completed may refer to the foregoing step S403, and details are not described herein.

S903, determine the Kth intermediate model as the training result.

The stabilization module 12 may adopt the Kth intermediate model as the training result of the neural network model while the iteration training is completed.

S904, determining the regularization term R.

The stabilization module 12 may determine the regularization term R based on the Kth intermediate model and the (K−1)th intermediate model while the iteration training is not completed.

In some embodiments, based on the embodiment shown in FIG. 8, the stabilization module 12 may determine the regularization term R by:

First, the stabilization module 12 may input the regularization data to the (K−1)th intermediate model to obtain the gradient of each weight in the (K−1)th intermediate model.

Then, the stabilization module 12 may determine the norm corresponding to the gradients of weights in the ith layer of the (K−1)th intermediate model (denoted as Gᵢ) and the norm corresponding to the gradients of all the weights the (K−1)th intermediate model (denoted as Gᵢ).

Next, the stabilization module 12 may determine the contribution of ith layer to the loss function corresponding to the (K−1)th intermediate model (denoted as αᵢ). For example, di may be calculated by Gᵢ/Gₐₗₗ.

Finally, the stabilization module 12 may determine the regularization term R in the loss function during the next loop of training based on the intermediate weights in the (K−1)th intermediate model, the intermediate weights in the Kth intermediate model and αᵢ.

In some embodiments, R may be calculated by Σαᵢ×Δᵢ, wherein Aᵢ is the difference between the intermediate weights in the ith layer of the (K−1)th intermediate model and the intermediate weights in the ith layer of the (K−1)th intermediate model.

Illustratively, assuming that the matrix corresponding to the intermediate weights in the ith layer of the (K−1)th intermediate model is Wᵢ₃ and the matrix corresponding to the intermediate weights in the ith layer of the Kth intermediate model is Wᵢ₄, Δᵢ₄; may be denoted as Σ|(Wᵢ₃(m)−-Wᵢ₄ (m))| or sqrt (Σ(Wᵢ₃(m)-Wᵢ₄ (m))²). Wherein Wᵢ₃ (m) denotes the mth element of the matrix Wᵢ₃, Wᵢ₄(m) denotes the mth element of the matrix Wᵢ₄, sqrt( ) denotes a square root, and |denotes an absolute value.

S905, update the regularization term in the train module 11.

After determining the regularization term R, the stabilization module 12 may update the regularization term R into the training module 11.

Illustratively, assuming that the loss function currently employed by the training module is L1=F+R0, the updated loss function L2 may be expressed as λ₁×F+λ₂×R. Wherein R0 is the regularization term in the loss function L1, λ₁ and λ₂ are any values that are not 0.

In some embodiments, the stabilization module 12 may also update the regularization term R into the loss function of the training module 11 in other ways, without limitation.

S906, proceed to the k+1 loop.

In some embodiments, after updating the regularization term in the training module 11, the stabilization module 12 may repeat the foregoing steps S901 to S905 to perform the (K+1)th loop of training based on the updated regularization term.

Based on the above method, the model training apparatus 10 can dynamically update the regularization term during the training process, thereby improving the converging speed of the neural network model training and the accuracy of the training result, and avoiding over-fitting.

Further, embodiments of the present disclosure further provide an electronic device 100 that can be used to deploy at least part of the modules of the foregoing model training apparatus 10. For example, the electronic device 100 may be used to deploy the training module 11 and/or the stabilization module 12.

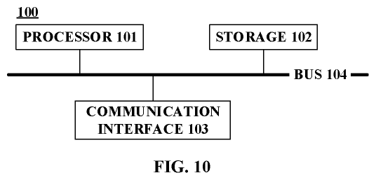

FIG. 10 shows a schematic structural diagram of an electronic device 100 according to some embodiments of the present disclosure.

As shown in FIG. 10, an electronic device 100 includes one or more processors 101, a memory 102, a communication interface 103, and a bus 104.

The processor 101 may include one or more processing units, for example, the processor 101 may include CPU (central processing unit), AP (application processor), GPU (graphics processing unit), ISP (image signal processor), DSP (digital signal processor), NPU (neural-network processing unit), ASIC(application-specific integrated circuit), and the like. The different processing units may be separate devices or may be integrated into one or more processors.

In some embodiments, the processor 101 may be configured to execute instructions to implement the model training methods provided by various embodiments of the present disclosure or implement the functions of the model training apparatus 10.

For example, the processor 101 may be configured to execute instructions to: perform iteration training of the neural network model, obtain intermediate models determined by the iteration training, determine aggregated model based on the intermediate models, determine regularization terms based on the aggregated model and the intermediate model, update model parameters and/or loss functions in the training module 11, and the like.

Memory 102 may include volatile memory and non-volatile memory for storing data and instructions.

The volatile memory may include RAM (random-access memory), DDR SDRAM (double data rate synchronous dynamic random access memory), and the like. The volatile memory is employed to temporarily store data and/or instructions. For example, in some embodiments, the volatile memory may be employed to temporarily store neural network models, training data, intermediate models, aggregated models, regularization terms, etc., or may be used to temporarily store instructions for execution by processor 101.

The non-volatile memory may include one or more tangible, non-transitory computer-readable media for storing data and/or instructions. In some embodiments, the nonvolatile memory may include any suitable nonvolatile memory, such as flash memory, and/or any suitable nonvolatile storage device, such as HDD (hard disk drive), CD (compact disc), DVD (digital versatile disc), SSD (solid-state drive), and the like.

In some embodiments, the non-volatile memory may also be a removable storage medium.

In some embodiments, the non-volatile memory may be employed to permanently store neural network models, training data, intermediate models, aggregated models, regularization terms, etc., or may be employed to permanently store instructions for execution by the processor 101.

In particular, the volatile memory and the non-volatile memory in the memory 102 may include a temporary copy and a permanent copy of the instruction 105, respectively. The instructions 105 may include causing the electronic device 100, when executed by at least one of the processors 101, to perform the model training method provided in the foregoing embodiments, or to perform at least some of the functions of the model training apparatus 10.

In some embodiments, the instructions 105 may include instructions for performing iteration training the neural network model, instructions for obtaining intermediate models in the iteration training of the neural network model, instructions for determining aggregated model based on the intermediate models, instructions for determining regularization terms based on the aggregated model and the intermediate model, instructions for updating model parameters/loss functions in the training module 11, and the like.

The communication interface 103 is configured to communicate between electronic devices 100 and other devices.

In some embodiments, communication interface 103 may include a transceiver for providing a wired or wireless communication interface for electronic device 100, such as an interface of an Ethernet, WAN (wireless access network), WLAN (wireless local area network), or the like.

In some embodiments, the electronic device 100 may establish a communication connection with other electronic devices through a communication interface 103, obtaining data from or transmitting data to other electronic devices. For example, when the electronic device 100 is a device in which the training module 11 is deployed, the electronic device 100 may transmit intermediate models to other devices through the communication interface 103, and receive aggregated model, regularization term, and the like from the other devices. For another example, when the electronic device 100 is a device in which the stabilization module 12 is deployed, the electronic device 100 may receive intermediate models from other devices through the communication interface 103, and transmit aggregated model, regularization term, and the like to the other device.

The bus 104 is used to connect the processor 101, the memory 102, and the communication interface 103 to enable communication between the processor 101, the memory 102, and the communication interface 103.

In other embodiments, the electronic device 100 may also include input/output devices, such as a keyboard, mouse, display screen, and the like.

It will be appreciated that the electronic device 100 may be any electronic device capable of executing instructions, including, but not limited to, a laptop computer, a desktop computer, a tablet computer, a mobile phone, a server, and the like, and is not limited herein.

It will be appreciated that the structure of the electronic device 100 shown in the embodiments of the present disclosure does not constitute a specific limitation on the electronic device 100. In other embodiments, electronic device 100 may include more or fewer components than shown, or may combine certain components, or may split certain components, or may have different component arrangements. The illustrated components may be implemented in hardware, software, or a combination of software and hardware.

1. An apparatus comprising:
a memory for storing instructions;
one or more processors for executing the instructions to cause the apparatus to perform actions comprising:
performing N iteration training on the first model, wherein N is an integer greater than one,
obtaining M intermediate models in the N iteration training processes, wherein M is an integer greater than one, and
aggregating the M intermediate models to a second model;
wherein said aggregating the M intermediate models to obtain the second model comprises:
aggregating the M intermediate models to obtain the second model based on M model weights and M statistics corresponding to the M intermediate models.

2. The apparatus of claim 1, wherein said performing the N iteration training on the first model comprises:
aggregating the preceding K intermediate models of the M intermediate models to obtain a Kth aggregated model,
updating the model weights and the statistics of the Kth aggregated model to the first model, and
determining the (K+1)th intermediate model of the M intermediate models by performing at least one iteration training on the updated first model; and
wherein said aggregating the preceding K intermediate models of the M intermediate models to obtain the Kth aggregated model comprises:
obtaining a (K−1)th aggregated model determined by aggregation of the Kth intermediate model and the preceding (K−1) intermediate models,
determining a third value corresponding to the model weight in the Kth aggregated model based on performing weighted summation on a first value of the model weight in the Kth intermediate model and a second value of the model weight in the Kth aggregated model, and
determining a sixth value corresponding to the statistics in the Kth aggregated model based on performing weighted summation on a fourth value of the statistics in the Kth intermediate model and a fifth value of the statistics in the Kth aggregated model.

3. The apparatus of claim 2, wherein said determining the (K+1)th intermediate model of the M intermediate models by performing the at least one iteration training on the updated first model comprises:
determining a regularization term based on the Kth intermediate model and the Kth aggregated model;
updating the loss function corresponding to the first model based on the regularization term; and
determining the (K+1)th intermediate model of the M intermediate models by performing at least one iteration training on the updated first model based on the updated loss function.

4. The apparatus of claim 3, wherein the first model comprises P layers, the model weight comprises a plurality of weights, and P is natural number; and
wherein said determining the regularization term based on the Kth intermediate model and the Kth aggregated model comprises:
determining gradient of each of the weights by inputting first data to the Kth aggregated model, determining the contribution of each layer to the loss function corresponding to the first model based on the gradient of each of the weights in each layer, and
determining the regularization term based on the contribution to the loss function corresponding to the first model of each layer, the first value of the model weight, and the third value of the model weight.

5. The apparatus of claim 4, wherein said determining the contribution of each layer to the loss function corresponding to the first model based on the gradient of each of the weights in each layer comprises:
determining first norm corresponding to the gradient of weights in the Qth layer, and second norm corresponding to the gradient of all weights in the first model, wherein Q is a natural number less than or equal to P; and
determining the quotient of the first norm divided by the second norm as the contribution to the loss function corresponding to the first model of the Qth layer; and
wherein the regularization term is determined according to the formula: R=Σα_{Q}×Δ_{Q}, wherein R is the regularization term, α_{Q} is the contribution to the loss function corresponding to the first model of Qth layer, Δ_{Q} is the difference between the data corresponding to the Qth layer network in the first value and the data corresponding to the Qth layer network in the third value.

6. The apparatus of claim 1, wherein said aggregating the M intermediate models based on the M model weights and the M statistics corresponding to the M intermediate models comprises:
determining the first intermediate model of the M intermediate models as the initial model of the second model, and aggregating the second intermediate model to the Mth intermediate model of the M intermediate models to the second model one by one; and
wherein the Pth intermediate model of the M intermediate models is aggregated to the second model by:
obtaining the Pth intermediate model, wherein the Pth intermediate model comprises a seventh value of the model weight and an eighth value of the statistics, 1<P≤M, and
updating the model weight in the second model to a ninth value, and updating the statistics in the second model to a tenth value, wherein the ninth value is the weighted sum of the seventh value and the current value of the model weight in the second model, the tenth value is the weighted sum of the eighth value and the current value of the statistics in the second model.

7. A method comprising:
performing N iteration training on the first model, wherein N is an integer greater than one;
obtaining M intermediate models in the N iteration training processes, wherein M is an integer greater than one; and
aggregating the M intermediate models to a second model;
wherein said aggregating the M intermediate models to obtain the second model comprises:
aggregating the M intermediate models to obtain the second model based on M model weights and M statistics corresponding to the M intermediate models.

8. The method of claim 7, wherein: said performing the N iteration training on the first model comprises:
aggregating the preceding K intermediate models of the M intermediate models to obtain a Kth aggregated model,
updating the model weights and the statistics of the Kth aggregated model to the first model, and
determining the (K+1)th intermediate model of the M intermediate models by performing at least one iteration training on the updated first model; and
wherein said aggregating the preceding K intermediate models of the M intermediate models to obtain the Kth aggregated model comprises:
obtaining a (K−1)th aggregated model determined by aggregation of the Kth intermediate model and the preceding (K−1) intermediate models,
determining a third value corresponding to the model weight in the Kth aggregated model based on performing weighted summation on a first value of the model weight in the Kth intermediate model and a second value of the model weight in the Kth aggregated model, and
determining a sixth value corresponding to the statistics in the Kth aggregated model based on performing weighted summation on a fourth value of the statistics in the Kth intermediate model and a fifth value of the statistics in the Kth aggregated model.

9. The method of claim 8, wherein said determining the (K+1)th intermediate model of the M intermediate models by performing the at least one iteration training on the updated first model comprises:
determining a regularization term based on the Kth intermediate model and the Kth aggregated model;
updating the loss function corresponding to the first model based on the regularization term; and
determining the (K+1)th intermediate model of the M intermediate models by performing at least one iteration training on the updated first model based on the updated loss function.

10. The method of claim 9, wherein the first model comprises P layers, the model weight comprises a plurality of weights, and P is natural number; and
wherein said determining the regularization term based on the Kth intermediate model and the Kth aggregated model comprises:
determining gradient of each of the weights by inputting first data to the Kth aggregated model;
determining the contribution of each layer to the loss function corresponding to the first model based on the gradient of each of the weights in each layer; and
determining the regularization term based on the contribution to the loss function corresponding to the first model of each layer, the first value of the model weight, and the third value of the model weight.

11. The method of claim 10, wherein said determining the contribution of each layer to the loss function corresponding to the first model based on the gradient of each of the weights in each layer comprises:
determining first norm corresponding to the gradient of weights in the Qth layer, and second norm corresponding to the gradient of all weights in the first model, wherein Q is a natural number less than or equal to P, and
determining the quotient of the first norm divided by the second norm as the contribution to the loss function corresponding to the first model of the Qth layer; and
wherein the regularization term is determined according to the formula: R=Σα_{Q}×Δ_{Q}, wherein R is the regularization term, do is the contribution to the loss function corresponding to the first model of Qth layer, Δ_{Q} is the difference between the data corresponding to the Qth layer network in the first value and the data corresponding to the Qth layer network in the third value.

12. The method of claim 7, wherein: aggregate the M intermediate models based on M model weights and M statistics corresponding to the M intermediate models comprising:
determine the first intermediate model of the M intermediate models as the initial model of the second model;
aggregate the second intermediate model to the Mth intermediate model of the M intermediate models to the second model one by one;
wherein the Pth intermediate model of the M intermediate models is aggregated to the second model by:
obtaining the Pth intermediate model, wherein the Pth intermediate model comprises a seventh value of the model weight and an eighth value of the statistics, 1<P≤M;
updating the model weight in the second model to a ninth value, and updating the statistics in the second model to a tenth value, wherein the ninth value is the weighted sum of the seventh value and the current value of the model weight in the second model, the tenth value is the weighted sum of the eighth value and the current value of the statistics in the second model.

13. A machine-readable storage medium storing instructions, wherein the instructions when executed by one or more processors of a machine, cause the machine to perform actions comprising:
performing N iteration training on the first model, wherein N is an integer greater than one;
obtaining M intermediate models in the N iteration training processes, wherein M is an integer greater than one; and
aggregating the M intermediate models to a second model;
wherein said aggregating the M intermediate models to obtain the second model comprises:
aggregating the M intermediate models to obtain the second model based on M model weights and M statistics corresponding to the M intermediate models.

14. The machine-readable storage medium of claim 13, wherein said performing the N iteration training on the first model comprises:
aggregating the preceding K intermediate models of the M intermediate models to obtain a Kth aggregated model;
updating the model weights and the statistics of the Kth aggregated model to the first model; and
determining the (K+1)th intermediate model of the M intermediate models by performing at least one iteration training on the updated first model.

15. The machine-readable storage medium of claim 14, wherein: said aggregating the preceding K intermediate models of the M intermediate models to obtain the Kth aggregated model comprises:
obtaining a (K−1)th aggregated model determined by aggregation of the Kth intermediate model and the preceding (K−1) intermediate models;
determining a third value corresponding to the model weight in the Kth aggregated model based on performing weighted summation on a first value of the model weight in the Kth intermediate model and a second value of the model weight in the Kth aggregated model; and
determining a sixth value corresponding to the statistics in the Kth aggregated model based on performing weighted summation on a fourth value of the statistics in the Kth intermediate model and a fifth value of the statistics in the Kth aggregated model.

16. The machine-readable storage medium of claim 15, wherein said determining the (K+1)th intermediate model of the M intermediate models by performing at least one iteration training on the updated first model comprises:
determining a regularization term based on the Kth intermediate model and the Kth aggregated model;
updating the loss function corresponding to the first model based on the regularization term; and
determining the (K+1)th intermediate model of the M intermediate models by performing at least one iteration training on the updated first model based on the updated loss function.

17. The machine-readable storage medium of claim 16, wherein the first model comprises P layers, the model weight comprises a plurality of weights, and P is natural number; and
wherein said determining the regularization term based on the Kth intermediate model and the Kth aggregated model comprises:
determining gradient of each of the weights by inputting first data to the Kth aggregated model,
determining the contribution of each layer to the loss function corresponding to the first model based on the gradient of each of the weights in each layer, and
determining the regularization term based on the contribution to the loss function corresponding to the first model of each layer, the first value of the model weight, and the third value of the model weight.

18. The machine-readable storage medium of claim 17, wherein said determining the contribution of each layer to the loss function corresponding to the first model based on the gradient of each of the weights in each layer comprises:
determining first norm corresponding to the gradient of weights in the Qth layer, and second norm corresponding to the gradient of all weights in the first model, wherein Q is a natural number less than or equal to P; and
determining the quotient of the first norm divided by the second norm as the contribution to the loss function corresponding to the first model of the Qth layer.

19. The machine-readable storage medium of claim 17, wherein said determining the regularization term based on the contribution to the loss function corresponding to the first model of each layer, the first value of the model weight, and the third value of the model weight comprises:
determine the regularization term according to the formula: R=Σα_{Q}×Δ_{Q}.
where R is the regularization term, α_{Q} is the contribution to the loss function corresponding to the first model of Qth layer, Δ_{Q} is the difference between the data corresponding to the Qth layer network in the first value and the data corresponding to the Qth layer network in the third value.

20. The machine-readable storage medium of claim 13, wherein said aggregating the M intermediate models based on the M model weights and the M statistics corresponding to the M intermediate models comprises:
determining the first intermediate model of the M intermediate models as the initial model of the second model, and
aggregating the second intermediate model to the Mth intermediate model of the M intermediate models to the second model one by one; and
wherein the Pth intermediate model of the M intermediate models is aggregated to the second model by:
obtaining the Pth intermediate model, wherein the Pth intermediate model comprises a seventh value of the model weight and an eighth value of the statistics, 1<P≤M, and
updating the model weight in the second model to a ninth value, and updating the statistics in the second model to a tenth value, wherein the ninth value is the weighted sum of the seventh value and the current value of the model weight in the second model, the tenth value is the weighted sum of the eighth value and the current value of the statistics in the second model.
